(19) United States
(12) Patent Application Publication
(10) Pub. No.: US 2024/0232964 A1
(43) Pub. Date: Jul. 11, 2024

(54) SYSTEM AND METHOD FOR ENCODING PRICING PLANS TO GENERATE A DIRECTED ACYCLIC GRAPH FOR AUTOMATICALLY GENERATING AN INVOICE BASED ON THE PRICING PLANS

(71) Applicant: Evolve Bits, Inc., New York, NY (US)

(72) Inventor: Saurabh Agrawal, New York, NY (US)

(21) Appl. No.: 18/095,452

(22) Filed: Jan. 10, 2023

(51) Int. Cl. G06Q 30/04

(52) U.S. Cl. CPC G06Q 30/04

(57) ABSTRACT

Disclosed is a method for encoding a usage-based pricing plan corresponding to at least one product or service to generate directed acyclic graph (DAG) in a machine-readable format, to automatically generate a customized invoice based on the usage-based pricing plan when an event triggers the DAG. The method includes: (i) encoding the usage-based pricing plan for the at least one product or service into the DAG template, to generate the DAG, (ii) storing the DAG in a machine-readable format to obtain machine-readable DAG, (iii) executing the machine-readable DAG to generate at least one invoice line item output, and (iv) automatically generating a customized invoice by obtaining the at least one invoice line output.

### BACKGROUND

### Technical Field

The present disclosure relates generally to construction of a directed acyclic graph, and more particularly, the present disclosure relates to a system and method for encoding pricing plans to generate the directed acyclic graph for automatically generating an invoice based on the pricing plans.

### Description of the Related Art

An invoice is a document that describes the goods and services that are offered to the clients/customers and the costs associated with the goods and services. The time and effort required to create and send invoices to customers can be reduced using billing software. In addition to accounting professionals, billing software can also be used by non-finance professionals like project managers or salespeople to provide quotations or pro forma invoices. Traditional pricing models include flat rate pricing for products and hourly rates for services. However, in industries such as software, where the product may also be offered as a service (e.g. for Software as a service), there is a need to adopt different types of complex pricing models such as usage based pricing, per user pricing, freemium pricing, tiered pricing, per feature pricing, per active user pricing, etc., depending on the usage, perceived value, and/or requirements of the customer. Research has shown that the pricing model makes a big difference to the revenue generated and growth of a software product company.

Existing billing software tools store orders, contracts, subscriptions, etc. as a linear list of line items. If certain units are provided free, or if a discount is provided, they have to be specified for each line item. Sometimes these line items are dependent on each other. Also, a hierarchical relationship can exist between line items. Different line items can also be bundled together into a pricing package. When a project manager or salesperson wants to customize a quotation for a specific client that is based on multiple products and/or services pricing plans, and these are represented as line items that are hierarchical or bundled together, it can lead to a lot of complexity as the number of computations to be performed increases. This can sometimes lead to errors. Further, these customizations require a lot of manual effort by an internal team or an external service provider. In addition, Software as a service (SaaS) companies utilize cloud computing platforms and services, for which the pricing models are also complex. The pricing model for cloud services maybe based on storage, usage, resources etc., which are also complex to compute.

Accordingly, there remains a need for addressing the aforementioned technical drawbacks in existing billing software.

### SUMMARY

In view of the foregoing, an embodiment herein provides a processor implemented method for encoding a first usage-based pricing plan corresponding to a first product or a first service to generate at least one directed acyclic graph (DAG) in a machine-readable format, to automatically generate a customized invoice based on the first usage-based pricing plan when at least one event triggers the execution of at least one DAG. The method includes (i) creating at least one DAG template that corresponds to at least one contract template, (ii) obtaining a first usage-based pricing plan for the first product or the first service, (iii) encoding the first usage-based pricing plan for the first product or the first service into the at least one DAG template, to generate the at least one DAG, (iv) storing the at least one DAG in a machine-readable format to obtain at least one machine-readable DAG, (v) executing the at least one machine-readable DAG by (a) obtaining at least one usage data of the first product or the first service, by interacting, using at least one fetch usage node of the at least one machine-readable DAG, (b) providing the at least one usage data as a first input to a first pricing node of the at least one machine-readable DAG, the first pricing node stores the first usage-based pricing plan, (c) providing the first usage-based pricing plan as a second input to the first pricing node of the at least one machine-readable DAG, and (d) generating, using the first pricing node, at least one invoice line item output by performing the at least one computation using on the at least one usage data and the first usage-based pricing plan, and (vi) automatically generating a customized invoice by obtaining the at least one invoice line item output. The at least one DAG includes a plurality of nodes. Each node of the at least one DAG includes (i) at least one output, and (ii) at least one computation that is configured to produce the at least one output.

In some embodiments, the method further includes (i) obtaining the at least one invoice line item output from the at least one machine-readable DAG, and (ii) generate a first invoice line item output corresponding to the first product or the first service, first credit entry, and first debit entry based on the at least one line item output, thereby balanced credit entries and debit entries are computed to automatically update balanced ledger entries in a book of accounts.

In some embodiments, the method further includes (i) obtaining (a) the first usage-based pricing plan for the first product or the first service, and (b) a second usage-based pricing plan for a second product or a second service, and (ii) encoding the first usage-based pricing plan and the second usage-based pricing plan into the at least one DAG template, to generate the at least one machine-readable DAG.

In some embodiments, the method further includes (i) generating, using the first pricing node and the second pricing node, the first invoice line item output corresponding to the first product or the first service and a second invoice line item output corresponding to the second product or the second service, (ii) providing the first invoice line item output and the second invoice line item output as inputs to a sum node of the at least one machine-readable DAG, and (iii) computing, using the sum node, the at least one invoice line item output by summing the first invoice line item output and the second invoice line item output.

In some embodiments, the method further includes (i) obtaining at least one event data that includes an information related to a context or a circumstance on which the at least one machine-readable DAG to be executed, and (ii) triggering the at least one machine-readable DAG for execution in response to obtaining the at least one event data.

In some embodiments, the first usage-based pricing plan and the second usage-based pricing plan includes at least one of a fixed per unit or use price, a fixed monthly price, a volume-based price, a tiered price, a custom currency-based price, a custom price, a currency conversion rate, free units, or a discount, the first pricing node includes at least one of a fixed per unit or per use pricing node, a fixed monthly pricing node, a volume-based pricing node, a tiered pricing node, a custom currency-based pricing node, a custom pricing node, a currency conversion node, a free unit node, or a discount node.

In some embodiments, generating the at least one invoice line item output includes (i) obtaining at least one event data for triggering execution of the at least one machine-readable DAG, and (ii) executing the at least one machine-readable DAG according to an order of execution specified by the at least one machine-readable DAG for (a) obtaining, using the at least one fetch usage node, at least one of the at least one usage data, a custom currency balance, a coupon for discount, or a trial coupon, (b) deducting, using the free unit node, free units from the at least one usage data if the first usage-based pricing plan includes the free units, (c) computing, using any of the fixed per unit or per use pricing node, the fixed monthly pricing node, the volume-based pricing node, or the tiered pricing node according to the order of execution, the at least one invoice line item output based on the at least one usage data or deducted usage data and the first usage-based pricing plan, and (d) deducting, using the discount node, a discount amount from the at least one invoice line item output if the first usage-based pricing plan includes a discount.

In some embodiments, generating the customized invoice further includes populating an invoice template with at least one of the at least one usage data, a billing period, the free units, the deducted usage data, or the discount amount, and the at least one invoice line item output.

In some embodiments, generating the at least one invoice line item output includes (i) obtaining the at least one event data for triggering execution of the at least one machine-readable DAG and (ii) executing the machine-readable DAG according to an order of execution specified by the at least one machine-readable DAG for (a) obtaining, using the at least one fetch usage node, the at least one usage data, (b) deducting, using the free unit node, free units from the at least one usage data if the second usage-based pricing plan includes the free units, (c) computing, using the custom currency-based pricing node, a custom currency-based invoice line item output based on the at least one usage data or deducted usage data, and (d) converting, using the currency conversion node, the custom currency-based invoice line item output into at least one currency format.

In some embodiments, the at least one DAG template includes at least one placeholder for obtaining the first usage-based pricing plan. The at least one placeholder is replaced by a node or the plurality of nodes by: (i) generating a user interface based on the at least one DAG template and obtaining the first usage-based pricing plan from a user via a user device to replace the at least one placeholder with the node or the plurality of nodes that stores the first usage-based pricing plan; or (ii) obtaining, via an application programming interface (API), the node or the plurality of nodes and the first usage-based pricing plan for replacing the at least one placeholder with the node or the plurality of nodes that stores the first usage-based pricing plan.

In some embodiments, the plurality of nodes of at least one DAG are reused across a plurality of customers, to generate a customized DAG for each customer, by encoding the first usage-based pricing plan corresponding to each customer into the at least one DAG template.

In some embodiments, the method includes computing at least one used entitlements and a balance amount by, (i) obtaining, using an entitlements balance node and the sum node, the customized invoice and a credit balance, and (ii) computing, by at least one entitlements deduction node, the at least one used entitlements and the balance amount using the customized invoice and the credit balance.

In some embodiments, the method includes computing the at least one invoice line item output using API calls by (i) obtaining usage API calls from API fetch usage node, (ii) obtaining credit API calls from the entitlements balance node, (iii) computing balance API calls by deducting the usage API calls received from the API fetch usage node and the credit API calls received from the entitlements balance node, and (iv) computing the at least one invoice line item output by multiplying the balance API calls with the per unit price of the API calls.

In another aspect, a system for encoding a first usage-based pricing plan corresponding to a first product or a first service to generate at least one directed acyclic graph (DAG) in a machine-readable format, to automatically generate a customized invoice based on the first usage-based pricing plan when at least one event triggers execution of the at least one DAG, is provided. The system includes a memory that stores a set of instructions, and a processor that is configured to execute the set of instructions to (i) create at least one DAG template that corresponds to at least one contract template, (ii) obtain a first usage-based pricing plan for a first product or a first service, (iii) encode the first usage-based pricing plan for the first product or the first service into the at least one DAG template, to generate the at least one DAG, (iv) store the at least one DAG in a machine-readable format to obtain at least one machine-readable DAG, (v) execute the at least one machine-readable DAG by (a) obtaining at least one usage data of the first product or the first service, by interacting, using at least one fetch usage node of the at least one machine-readable DAG; (ii) providing the at least one usage data as a first input to a first pricing node of the at least one machine-readable DAG, the first pricing node stores the first usage-based pricing plan; (iii) providing the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan, and (vi) automatically generate a customized invoice by obtaining the at least one invoice line item output. The at least one DAG includes a plurality of nodes. Each node of the at least one DAG includes (i) at least one output, and (ii) at least one computation that is configured to produce the at least one output.

In some embodiments, the processor is further configured to (i) obtain the at least one invoice line item output from the at least one machine-readable DAG, and (ii) generate the first invoice line item output corresponding to the first product or the first service, first credit entry, and first debit entry based on the at least one line item output, thereby balanced credit entries and debit entries are computed automatically to update balanced ledger entries in a book of accounts.

In some embodiments, the processor is further configured to (i) obtain (a) the first usage-based pricing plan for the first product or the first service, and (ii) a second usage-based pricing plan for a second product or a second service, and (b) a second usage-based pricing plan for at least one second product or service, and (ii) encode the first usage-based pricing plan and the second usage-based pricing plan into the at least one DAG template, to generate the at least one machine-readable DAG, (iii) generate, using the first pricing node and the second pricing node, a first invoice line item output corresponding to the first product or the first service and a second invoice line item output corresponding to the second product or the second service, (iv) provide the first invoice line item output and the second invoice line item output as inputs to a sum node of the at least one machine-readable DAG, and (v) compute, using the sum node, the at least one invoice line item output by summing the first invoice line item output and the second invoice line item output.

In some embodiments, the processor is further configured to (i) obtain at least one event data that includes an information related to a context or a circumstance on which the at least one machine-readable DAG to be executed, and (ii) trigger the at least one machine-readable DAG for execution in response to obtaining the at least one event data.

In some embodiments, generating the at least one invoice line item output includes (i) obtaining the at least one event data for triggering execution of the at least one machine-readable DAG, and (ii) executing the at least one machine-readable DAG according to an order of execution specified by the at least one machine-readable DAG for (a) obtaining, using the at least one fetch usage node, the at least one usage data, (b) deducting, using the free unit node, free units from the at least one usage data if the first usage-based pricing plan includes the free units, (c) computing, using any of the fixed per unit or per use pricing node, the fixed monthly pricing node, the volume-based pricing node, or the tiered pricing node according to the order of execution, the least one invoice line item output based on the at least one usage data or deducted usage data and the first usage-based pricing plan, and (d) deducting, using the discount node, a discount amount from the least one invoice line item output if the first usage-based pricing plan includes a discount.

In some embodiments, the processor is further configured to generate the at least one invoice line item output includes (i) obtaining at least one event data for triggering execution of the at least one machine-readable DAG, and (ii) executing the machine-readable DAG according to an order of execution specified by the at least one machine-readable DAG for (a) obtaining, using the at least one fetch usage node, the at least one usage data, (b) deducting, using the free unit node, free units from the at least one usage data if the second usage-based pricing plan includes the free units, (c) computing, using the custom currency-based pricing node, a custom currency-based invoice line item output based on the at least one usage data or deducted usage data, (d) converting, using the currency conversion node, the custom currency-based invoice line item output into at least one currency format.

In yet another aspect, one or more non-transitory computer-readable storage mediums storing the one or more sequences of instructions, which when executed by the one or more processors, causes to perform a method of encoding a first usage-based pricing plan corresponding to a first product or a first service to generate at least one directed acyclic graph (DAG) in a machine-readable format, to automatically generate a customized invoice based on the first usage-based pricing plan when at least one event triggers execution of the at least one DAG, is provided. The method includes (i) creating at least one DAG template that corresponds to at least one contract template, (ii) obtaining a first usage-based pricing plan for a first product or a first service, (iii) encoding the first usage-based pricing plan for the first product or the first service into the at least one DAG template, to generate the at least one DAG, (iv) storing the at least one DAG in a machine-readable format to obtain at least one machine-readable DAG, (v) executing the at least one machine-readable DAG by (a) obtaining at least one usage data of the first product or the first service, by interacting, using at least one fetch usage node of the at least one machine-readable DAG; (ii) providing the at least one usage data as a first input to a first pricing node of the at least one machine-readable DAG, the first pricing node stores the first usage-based pricing plan; (iii) providing the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan, and (vi) automatically generating a customized invoice by obtaining the at least one invoice line output. The at least one DAG includes a plurality of nodes. Each node of the at least one DAG includes (i) at least one output, and (iii) at least one computation that is configured to produce the at least one output.

The system and the method for generating a customized invoice based on the at least one usage-based pricing plan when at least one event triggers the at least one DAG, are provided. The DAG contract helps a user to construct a customized template very easily. The system avoids creating duplicate versions of pricing plans. The system eliminates the cluttering of user interface features that are unused. The system implements custom currencies with all flexible pricing plans.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system for encoding at least one usage-based pricing plan corresponding to at least one product or service to generate at least one directed acyclic graph (DAG) in a machine-readable format, to automatically generate an invoice based on the at least one usage-based pricing plan according to some embodiments herein;

FIG. 2 is a block diagram that illustrates one or more modules of a server of FIG. 1 according to some embodiments herein;

FIG. 3 illustrates a first exemplary directed acyclic graph (DAG) based contract according to some embodiments herein;

FIG. 4A illustrates a third exemplary directed acyclic graph (DAG) based contract for generating an invoice for a plurality of products according to some embodiments herein;

FIG. 4B illustrates an exemplary invoice that is generated using DAG based contract of FIG. 4A according to some embodiments herein;

FIG. 5A illustrates a first exemplary directed acyclic graph (DAG) template according to some embodiments herein;

FIG. 5B illustrates a first exemplary user interface generated based on the DAG template of FIG. 5A according to some embodiments herein;

FIG. 6A illustrates a second exemplary directed acyclic graph (DAG) template according to some embodiments herein;

FIG. 6B illustrates a second exemplary user interface generated based on the DAG template of FIG. 6A according to some embodiments herein;

FIG. 7 illustrates an exemplary diagram of generating balanced ledger entries in a book of accounts according to some embodiments herein;

FIG. 8A illustrates an exemplary diagram of computing entitlements based on credits offered according to some embodiments herein;

FIG. 8B illustrates an exemplary diagram of computing the invoice line item output based on API calls offered according to some embodiments herein;

FIGS. 9A-9B are flow charts that illustrate a method for encoding at least one usage-based pricing plan corresponding to at least one product or service to generate at least one directed acyclic graph (DAG) in a machine-readable format, to automatically generate an invoice based on the at least one usage-based pricing plan according to some embodiments herein; and

FIG. 10 is a schematic diagram of computer architecture of a server in accordance with some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

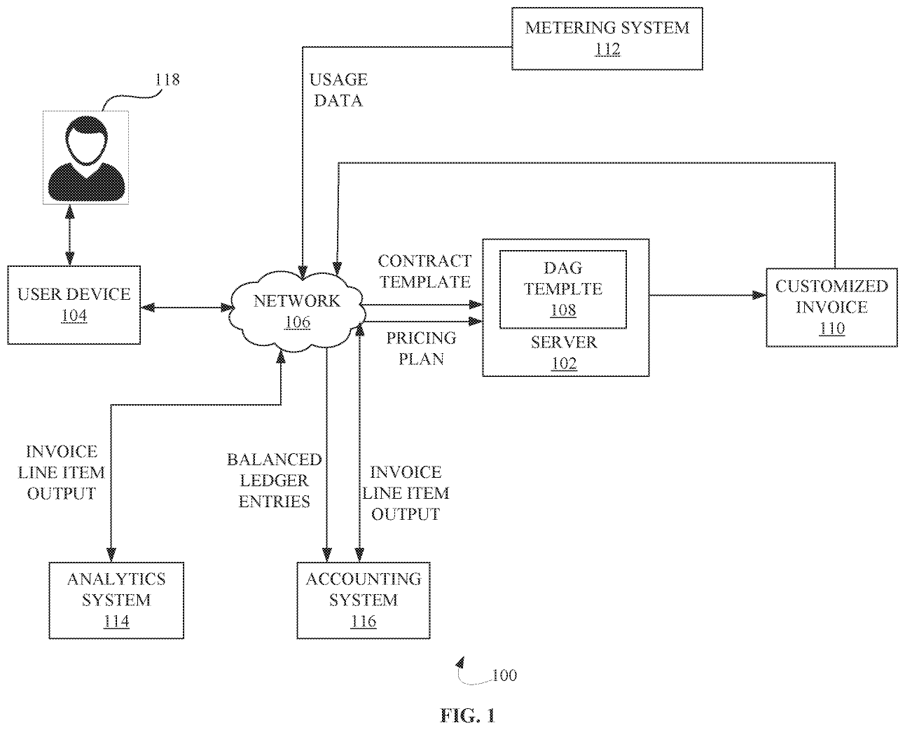

As mentioned, there remains a need for an improved technical approach for generating at least one directed acyclic graph (DAG) based on at least one usage-based pricing plan for generating an invoice. Referring now to the drawings, and more particularly to FIGS. 1 through 10, where similar reference characters denote corresponding features consistently throughout the figures, preferred embodiments are shown.

As used herein, several terms are defined below:

The term “usage-based pricing plan” refers to a pricing plan where customers are charged based on their usage of a product/service within a given billing cycle.

The term “product or service” refers to any intangible item or tangible item that is offered for customer use according to a demand of a customer.

The term “directed acyclic graph (DAG)” refers to a conceptual representation of a series of activities. The order of the activities is depicted by a graph, which is visually presented as a set of rectangles (nodes), each one representing an activity, some of which are connected by lines (edges), which represent the flow from one activity to another.

The term “contract template” refers to a pre-written document with the terms and conditions laid out by one party to another.

The term “DAG template” defines a structure or skeleton of a DAG. DAG template allows a user to define tasks as a graph of dependencies.

The term “computation” refers to a logic or calculation that is configured to generate at least one output (e.g., invoice line-item output, amount=price*quantity).

The term “pricing node” refers to a node that is configured to generate or determine price for usage of a product or service. The pricing node includes, but not limited to, a fixed per unit pricing node, a fixed per use pricing node, a fixed monthly pricing node, a volume-based pricing node, a tiered pricing node, a custom currency-based pricing node, a custom pricing node, a currency conversion node, a free unit node, or a discount node

The term “fetch usage node” refers to a node that is configured to obtain data from a unit/device/system/database etc. For example, data may be fetched from an external system either via a structured query language (SQL) query from a database or a data warehouse or a data lake, or via an API call from an external or internal system.

The term “invoice line-item output” refers to an output from at least one node of the DAG that is used to create the line items that go in the final invoice document that is sent to the customer.

The term “usage data” refers to any data about how a product or service is used. The term “API calls” refers to the number of API calls that were sent to the server requesting for a service to be rendered. The term “total storage used in GB” refers to storage capacity in giga bytes, approximately equivalent to billion bytes. The total hours of CPU used refers to the exact amount of time that the CPU is used for processing instructions of a computer program or operating system. Examples of usage data may be revenue processed, payments processed, number of API calls, total storage used in GB, total hours of CPU used, etc. The term “revenue processed” is the revenue that is processed. The term “payments processed” is the payments that are processed.

FIG. 1 is a block diagram that illustrates a system 100 for encoding at least one usage-based pricing plan corresponding to at least one product or service to generate at least one directed acyclic graph (DAG) 108 in a machine-readable format, to automatically generate a customized invoice 110 based on the at least one usage-based pricing plan according to some embodiments herein. The system 100 includes a server 102, a user device 104, a metering system 112, an analytics system 114, and an accounting system 116. The server 102 includes a memory that stores a set of instructions, and a processor that is configured to execute the set of instructions to generate the at least one DAG 108 based on the at least one usage-based pricing plan for automatically generating the invoice 110. The server 102 may be an in-house server or a cloud server. The server 102 is communicatively connected with all external systems including at least one of the user device 104, the metering system 112, the analytics system 114, and the accounting system 116, via a network 106. The network 106 may be a local area network (LAN), a wide area network (WAN), a public network, a private network, a proprietary network, a Public Telephone Switched Network (PSTN), the Internet, a wireless network, a virtual network, a wired network or any combination thereof. In some embodiments, the server 102, the user device 104, the metering system 112, the analytics system 114, and the accounting system 116 are connected in a peer-to-peer (P2P) network. The user device 104 may be a mobile phone, a smartphone, a laptop, a hand-held device, a smart wearable device, a kindle, a PDA (Personal Digital Assistant), a tablet, a computer, an electronic notebook, or any combination thereof.

The server 102 is configured to create a DAG template that corresponds to a contract template. The contract template may be in a natural language or in a machine-readable format. The contract template includes a set of conditions governed between two parties. In some embodiments, the contract template is created via an application program interface (API), or via an interface by a user 118. In some embodiments, the contract template is selected based on an input. The input may include at least one of a name of a product or service to be accessed, name of parties etc. The contract template includes default pricing models for products. The contract template may create a user interface. The user may use the user interface to override the default pricing models. The overrides may also be specified using the API. The DAG template includes a placeholder for obtaining a usage-based pricing plan. The default pricing models may be stored in the memory of the server 102.

The server 102 is configured to obtain the first usage-based pricing plan for a first product or a first service based on the DAG template. In some embodiments, the DAG template includes a placeholder where the user may enter pricing details specific to a particular customer. In some embodiments, the placeholder is replaced by a node or the plurality of nodes by generating the user interface and obtaining the first usage-based pricing plan from the user 118 via the user device 104 to replace the placeholder with the node or the plurality of nodes that stores the first usage-based pricing plan. In some embodiments, the placeholder is replaced by the node or the plurality of nodes by obtaining, via API, the node or the plurality of nodes and the first usage-based pricing plan for replacing the placeholder with the node or the plurality of nodes that stores the first usage-based pricing plan.

The server 102 is configured to encode the first usage-based pricing plan for the first product or the first service into the DAG template, to generate the DAG. The first usage-based pricing plan is stored in a machine readable DAG storage of the DAG based contract. The DAG includes one or more nodes. Each node of the DAG includes (i) input, (which is optional) (ii) output, and (iii) computation that is configured to produce the output. The server 102 is configured to store the DAG in a machine-readable format. The machine-readable DAG includes at least one of a YAML, extensible markup language (XML), JavaScript object notation (JSON), custom built DSL (domain specific language), or a programming language, or a custom programming language.

The server 102 is configured to execute the machine-readable DAG. The server 102 is configured to obtain the usage data of the first product or first service using at least one fetch usage node of the at least one machine-readable DAG. The server 102 is configured to provide the usage data as a first input to a first pricing node of the machine-readable DAG. The usage data may be an output from another fetch usage data node. The server 102 provides the first usage-based pricing plan as a second input to the first pricing node of the machine-readable DAG. The non-quantity inputs together may be called as the first usage-based pricing plan. The first usage-based pricing plan includes at least one of the non-quantity inputs like a fixed per unit or use price, a fixed monthly price, a volume-based price, a custom currency-based price, a custom price, a currency conversion rate, free units, percent of revenue, percent of assets under management, percent of transaction value, any custom pricing node, or a discount. The first usage-based pricing plan may be stored in a machine-readable DAG storage of the server 102. The pricing node includes at least one of a fixed per unit or per use pricing node, a fixed monthly pricing node, a volume-based pricing node, a tiered pricing node, a custom currency-based pricing node, a custom pricing node, a currency conversion node, a free unit node, a stairstep pricing node, or a discount node.

The server 102 is configured to generate an invoice line item output by performing the computation on the usage data and the first usage-based pricing plan. The server 102 is configured to generate a customized invoice by obtaining the invoice line item output. The usage-based pricing plan is stored in the machine readable DAG storage of the DAG.

The server 102 is configured to populate an invoice template with the invoice line item outputs and non-invoice line item data. The invoice line item output may include at least one of the usage data, a billing period, the free units, the deducted usage data, or the discount amount, etc. The non-invoice line item data may include billing period, customer information like company address, payment period, etc.

The accounting system 116 is communicatively connected to the server 102. The server is configured to generate the invoice line item output corresponding to the first product or the first service. The server 102 is configured to generate a credit entry, and a debit entry corresponding to the line item output, thereby balanced credit entries and debit entries are computed to automatically update balanced ledger entries in a book of accounts. The accounting system 116 may include the book of accounts.

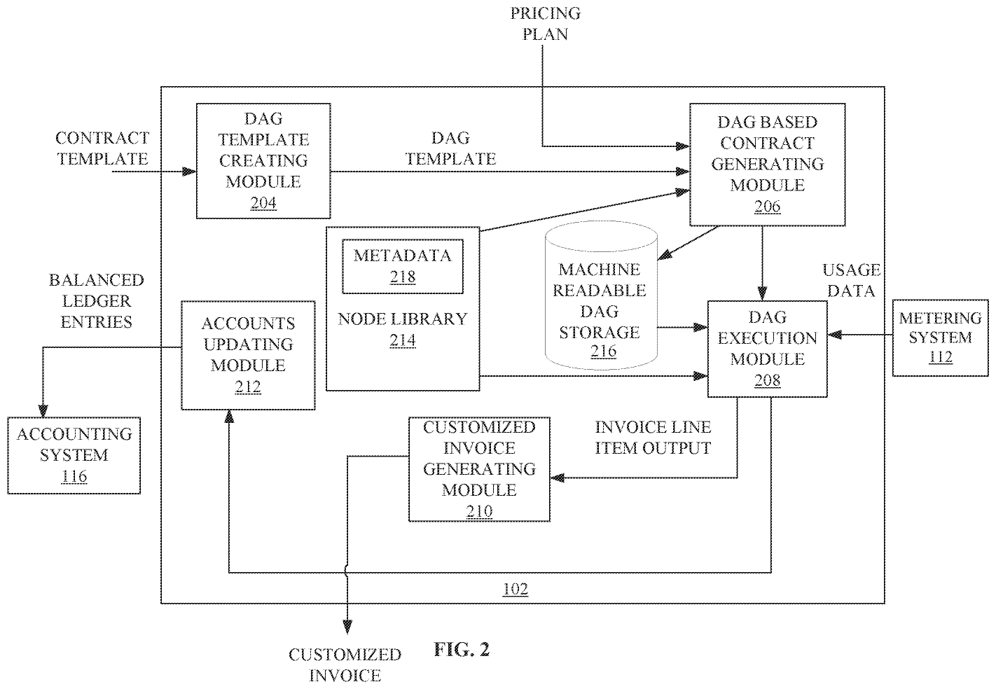

FIG. 2 is a block diagram that illustrates one or more modules of a server of FIG. 1 according to some embodiments herein. The server 102 includes a DAG template creating module 204, a DAG based contract generating module 206, a DAG execution module 208, an invoice generating module 210, an accounts updating module 212, a node library 214, and a machine readable DAG storage 216. The DAG template creating module 204 obtains the contract template as input. The DAG template creating module 204 creates a DAG template that corresponds to the contract template.

The node library 214 stores the pricing node of the machine-readable DAG. The node library 214 may also store other nodes like sum node, sales tax node, etc. The pricing node may be at least one of a fixed per unit or per use pricing node, a fixed monthly pricing node, a volume-based pricing node, a tiered pricing node, a custom currency-based pricing node, a custom pricing node, a currency conversion node, a free unit node, a stairstep pricing node, or a discount node. The machine readable DAG storage 216 stores the machine-readable DAG.

The DAG based contract generating module 206 obtains a usage-based pricing plan for a product or a service. The DAG based contract generating module 206 generates the DAG by encoding the usage-based pricing plan for the product or service into the DAG template. The usage-based pricing plan is stored in the machine readable DAG storage 216. The DAG execution module 208 executes the machine-readable DAG. The DAG execution module 208 obtains the usage data of the product or the service using a fetch usage node of the machine-readable DAG. The DAG execution module 208 provides the usage data as a first input to a first pricing node of the machine-readable DAG. The non-quantity inputs together may be called as the first usage-based pricing plan. The first usage-based pricing plan includes at least one of the non-quantity inputs like a fixed per unit or use price, a fixed monthly price, a volume-based price, a custom currency-based price, a custom price, a currency conversion rate, free units, percent of revenue, percent of assets under management, percent of transaction value, any custom pricing node, or a discount. The DAG execution module 208 provides the first usage-based pricing plan as a second input to the first pricing node of the machine-readable DAG. The DAG execution module 208 generates invoice line item output by performing the computation on the usage data and the first usage-based pricing plan using the first pricing node.

The invoice generating module 210 generates a customized invoice by obtaining the invoice line item output.

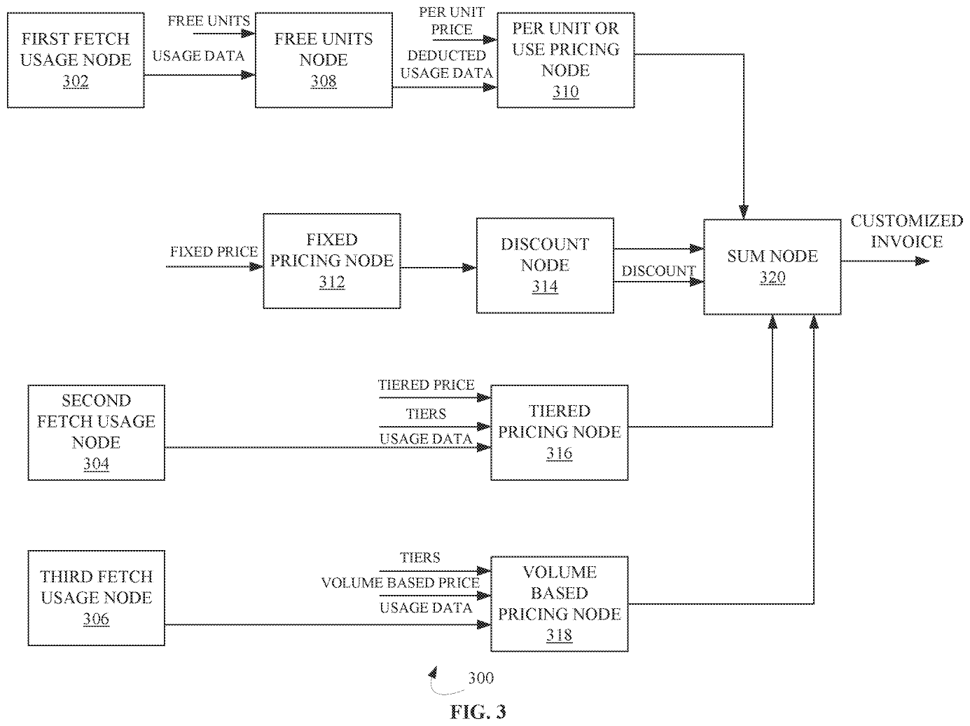

FIG. 3 illustrates a first exemplary directed acyclic graph (DAG) 300 based contract according to some embodiments herein. The first exemplary DAG 300 based contract includes a first fetch usage node 302, a second fetch usage node 304, a third fetch usage node 306, a free units node 308, a per unit or use pricing node 310, a fixed pricing node 312, a discount node 314, a tiered pricing node 316, a volume based pricing node 318 and a sum node 320.

The first fetch usage node 302 includes a first usage-based pricing plan for a first product or service to determine a first usage data. The free units node 318 obtains free units if the first usage-based pricing plan includes free units. The free units node 318 obtains the first usage data from the first fetch usage node 302 based on the first usage-based pricing plan. The free units node 318 deducts the free units from the first usage data to obtain deducted first usage data. The per unit or use pricing node 310 computes a first invoice line item output based on the deducted first usage data and per unit price. Thereby, the per unit or use pricing node 310 provides the first invoice line item output to the sum node 320.

The fixed pricing node 312 computes a second invoice line item output based on a second pricing plan for a second product or service. The second usage-based pricing plan may be a fixed subscription amount for every billing cycle. The discount node 314 deducts a discount amount from the second invoice line item output if the second usage-based pricing plan includes a discount. Thereby, the discount node 314 provides the second invoice line item output to the sum node 320.

The third fetch usage node 306 includes a third usage-based pricing plan for a third product or service to determine a third usage data. The volume based pricing node 318 computes a third invoice line item output by obtaining the third usage data from the third fetch usage node 306, volume tiers and corresponding prices of the volume tiers. Thereby, the volume based pricing node 318 provides the third invoice line item output to the sum node 320. The second fetch usage node 304 obtains a fourth usage-based pricing plan for a fourth product or service to determine a fourth usage data. The tiered pricing node 316 computes the fourth invoice line item output using the fourth usage data, tiers, and prices corresponding to the tiers.

The sum node 320 obtains the first invoice line item output, the second invoice line item output, the third invoice line item output and the fourth invoice line item output from the per unit or use pricing node 310, the discount node 314, the volume based pricing node 318, and tiered pricing node 316. The sum node 320 computes the invoice line item output by summing the first invoice line item output, the second invoice line item output, the third invoice line item output, and the fourth invoice line item output.

In an exemplary embodiment, the following code is used for computing the output free units granted and the output remaining quantity is given below. The below code is implemented in free units node 308 to generate the first invoice line item output.

```
inputs:
  - free_quantity
  - quantity
outputs:
  - free_units_granted
  - remaining_quantity
computation:
  - outputs.free_units_granted = min(inputs.quantity,
  inputs.free_quantity)
  - outputs.remaining_quantity = max(inputs.quantity −
  inputs.free_quantity, 0)
```

In an exemplary embodiment, the following code is used for per unit price of the used data/service by the customer. The following code is implemented in per unit or use pricing node 310. The per unit price and the usage quantity of the customer are taken as the inputs and compute the line item output by multiplying per unit price and the usage quantity.

```
inputs:
  - price
  - quantity
outputs:
  - amount
computation:
  - outputs.amount = inputs.price * inputs.quantity.
```

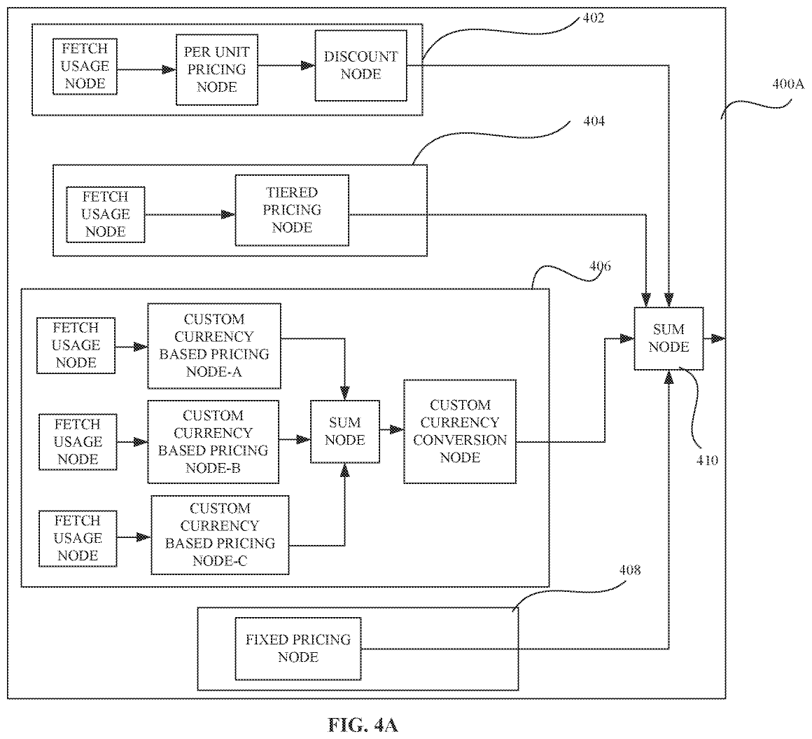

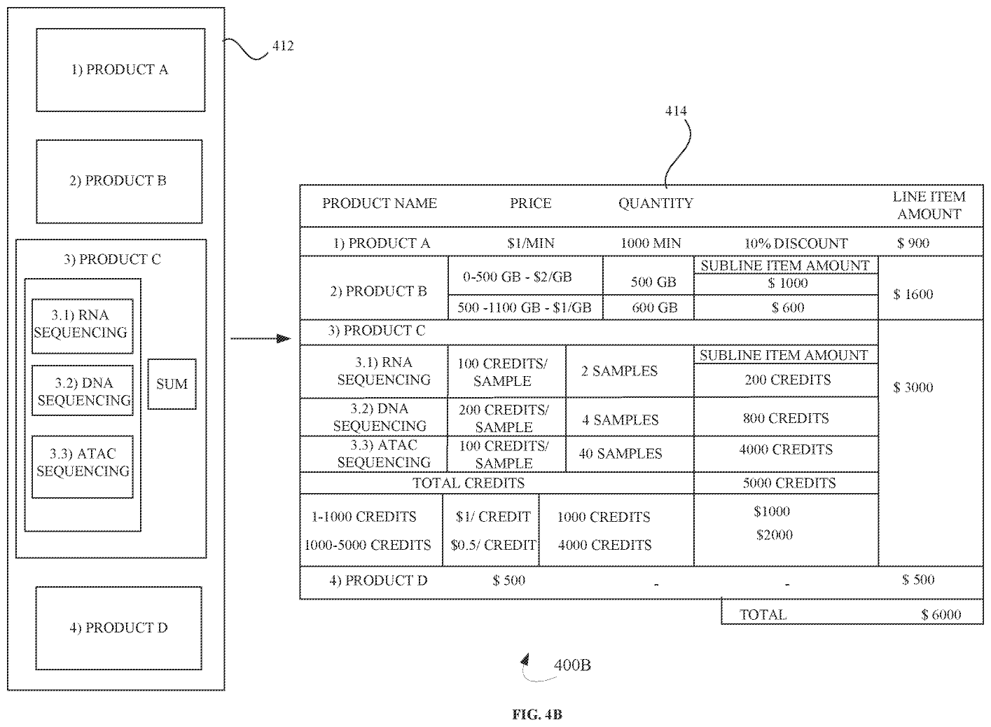

FIG. 4A illustrates an exemplary directed acyclic graph (DAG) based contract 400A for generating a customized invoice 110 for a plurality of products according to some embodiments herein. At 402 (i.e. for a first product), the third exemplary DAG based contract 400A includes (i) determining the first usage data using the fetch usage node based on the first usage-based pricing plan, (ii) deducting, by the free units node, the free units from the first usage data to obtain deducted first usage data, (iii) computing, by a per unit or use pricing node, a first invoice line item output based on the deducted first usage data and per unit price and (iv) deducting, by the discount node, a discount amount from the first invoice line item output if the first usage-based pricing plan includes a discount.

At 404 (i.e. for a second product), the third exemplary DAG based contract 400A includes (a) determining the second usage data using the fetch usage node based on the second usage-based pricing plan, (b) computing, by a tiered pricing node, a second invoice line item output.

At 406, the third exemplary DAG based contract 400A includes (i) computing a first custom currency-based invoice line item output by a custom currency based pricing node A, (ii) computing a second custom currency-based invoice line item output by a custom currency based pricing node B, (iii) computing a third custom currency-based invoice line item output by a custom currency based pricing node C, (iv) computing a third invoice line item output by converting the custom currency-based invoice line item output, the custom currency-based invoice line item output is obtained by summing the first converted custom currency-based invoice line item output, the second converted custom currency-based invoice line item output, and the third converted custom currency-based invoice line item output.

At 408, the third exemplary DAG based contract 400A includes (a) computing a fourth invoice line item output based on a fixed pricing plan for a fourth product or service.

At 410 (e.g. at a sum node), the third exemplary DAG based contract 400A includes computing the final invoice line item output by summing the first invoice line item output, the second invoice line item output, the third invoice line item output, and the fourth invoice line item output.

FIG. 4B illustrates an exemplary customized invoice 400B that is generated using the DAG based contract of FIG. 4A according to some embodiments herein. The exemplary customized invoice 412 includes details of each product or service and total in a row. In some embodiments, the details of each product or service are depicted in a row and total in another row. The line item amount, sub-line item amounts of each product may be included as columns as depicted in 414. The number of columns may not be fixed in nature. As depicted in 414, each line item has a different number of columns, and different types of columns. For example, the line item of product B has different columns, that is sub line item amount for 0-500 GB-$2/GB, and 500-1100 GB-$1/GB are depicted as separate columns, the line item amount as one column. The sub-line item amount of product C has different types of columns and number of columns when compared to the columns of product A, product B, and product D. The columns of product C include different columns, like in the case of hierarchy. Based on the type of node, the number and type of columns may change. For example, in case of product C, the node may be a tiered node, thereby, the columns are different compared to product A, product B, and product D. The exemplary invoice 400B depicts product A, product B, product C, and product D. The product C includes RNA sequencing, DNA sequencing, ATAC sequencing. The price column for each product, if it exists, provides the price for each unit, for example, the price for product A is mentioned as $1/minute of usage. The price for product B is mentioned as 0-500 GB-$2/GB, and 500-1100 GB-$1/GB. The price for RNA sequencing is mentioned as 100 credits/sample. The price for DNA sequencing is mentioned as 200 credits/sample. The price for ATAC sequencing is mentioned as 100 credits/sample.

The quantity column of the exemplary invoice 400B provides the quantity of the product, for example, the quantity of product A is 1000 minutes, the quantity of product B is 1100 GB. The pricing model for product B is tiered pricing model, with the first 500 GB that is priced at $2/GB and the rest at $1/GB. The product C is a group of 3 products, that is RNA sequencing samples, DNA sequencing samples and ATAC sequencing samples. For example, each priced in an intermediate currency called “Credits”. The credits are priced in dollars using the tiered pricing model, with the first 1000 credits priced at $1/credit and the rest priced at $0.5/credit. The quantity of RNA sequencing samples is 2 samples priced at 100 credits per sample amounting to a total of 200 credits, the quantity of DNA sequencing samples is 4 samples priced at 200 credits per sample, quantity of ATAC sequencing samples is 40 samples priced at 100 credits per sample. Thereby, the total credits will be 5000 credits. The pricing for 0-1000 credits may be $1/credit, and 1000-4000 credits may be $0.5/credit.

The subline item amount column of the exemplary invoice 400B depicts the tiered invoice line item amount for product B and is shown as $1000, $600. $1000 is priced for 0-500 GB, and $600 is priced for 500-1100 GB. The custom currency based pricing for RNA sequencing is 200 credits, the custom currency based pricing for DNA sequencing is 800 credits, the custom currency based pricing for ATAC sequencing is 4000 credits. The total credits will be 5000 credits. As the pricing for 0-1000 credits is $1/credit, and 1000-4000 credits is $0.5/credit, the total pricing for product C is $3000.

The line item amount column of the exemplary invoice 400B depicts the first line item amount for product A as $900, the second line item amount for product B as $1600, the third line item amount for product C as $3000, the fourth line item amount for product D as $500. The final line item amount that is obtained by summing the first line item amount for product A, the second line item amount for product B, the third line item amount for product C, the fourth line item amount is depicted as total that is $6000.

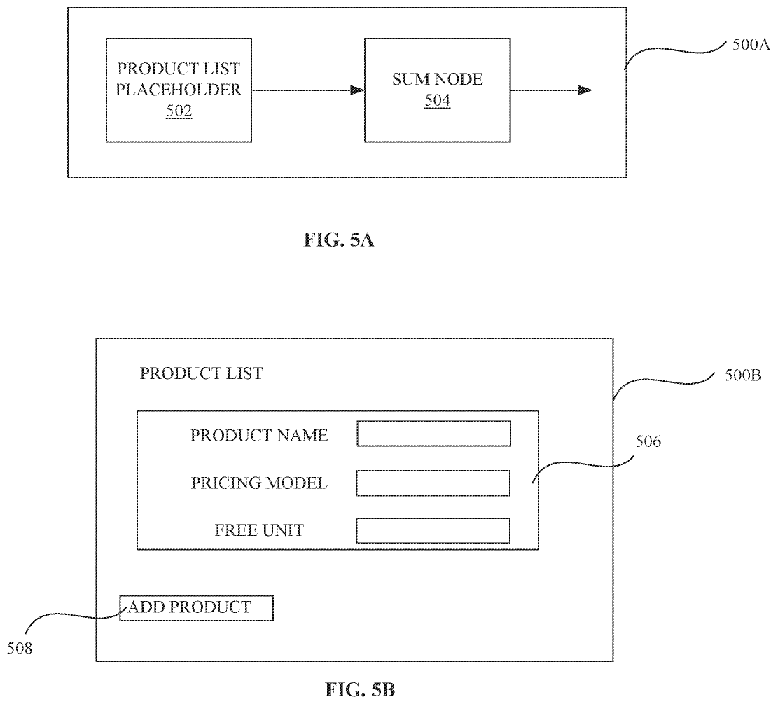

FIG. 5A illustrates a first exemplary directed acyclic graph (DAG) template 500A according to some embodiments herein. The first exemplary DAG template 500A includes a product list placeholder 502, and a sum node 504. The product list placeholder 502 indicates a linear list of products with corresponding pricing plans. The sum node 504 computes the invoice line item. The first exemplary DAG template 500A generates a user interface to add products to the product list and enter pricing details specific for a particular contract.

FIG. 5B illustrates a first exemplary user interface 500B generated based on the DAG template of FIG. 5A according to some embodiments herein. The first exemplary user interface generated 500B includes a product list 506, and an add product button 508.

The product list 506 may include a product name, a pricing model, a free unit among other inputs that are available. The add product button 508 may be used if any extra product needs to be added.

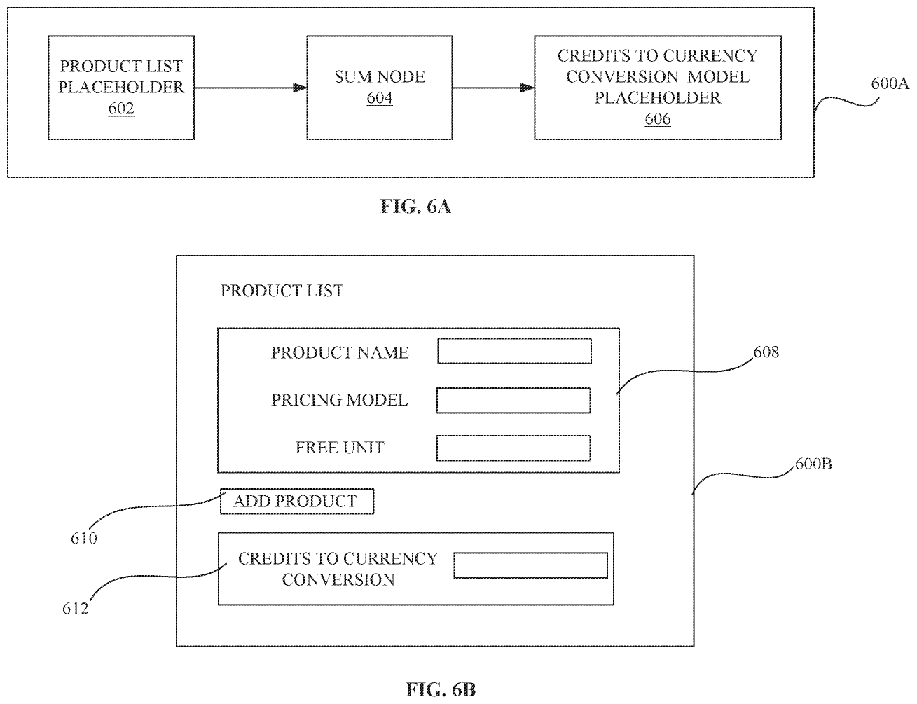

FIG. 6A illustrates a second exemplary directed acyclic graph (DAG) template according to some embodiments herein. The second exemplary DAG template 600 A includes a product list placeholder 602, a sum node 604, and a credits to currency conversion model placeholder 606.

The second exemplary DAG template 600A generates a user interface to add products to the product list and enter pricing details specific for a particular contract. The product list placeholder 602 indicates the filled linear list of products with the corresponding pricing plans. The products in the product list may be priced in custom currency, for example, credits. The credits to currency conversion placeholder 606 includes a pricing model to convert a custom currency to a real-world currency. The custom currency may be credits.

FIG. 6B illustrates a second exemplary user interface generated 600B based on the DAG template of FIG. 6A according to some embodiments herein. The second exemplary user interface generated 600B includes a product list 608, an add product button 610, and a credits to currency conversion 612. The second exemplary user interface generated 600B may include a product name, a pricing model, and a free unit among other inputs available. The add product button 610 may be used if any extra product needs to be added. The credits to currency conversion 612 includes a pricing model for converting credits into respective currency.

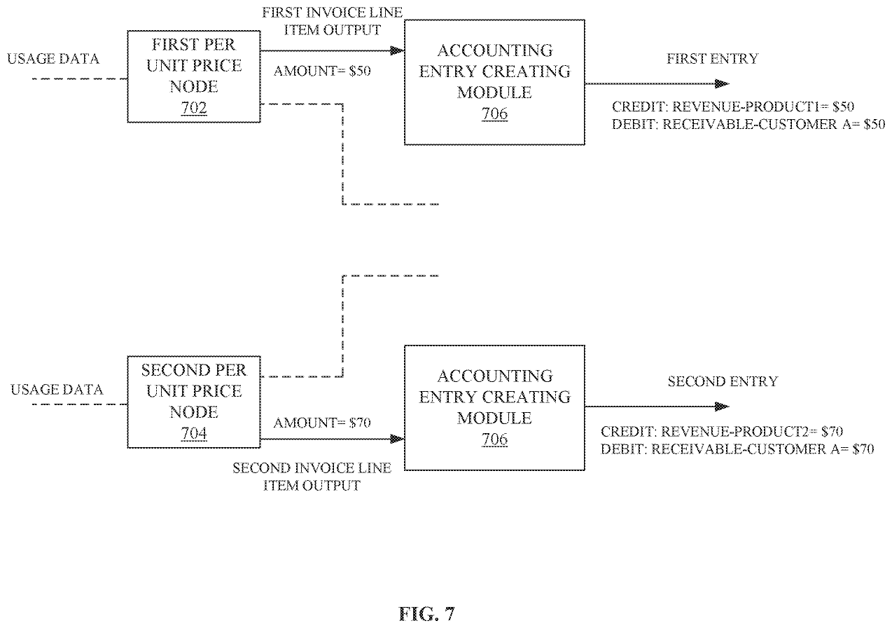

FIG. 7 illustrates an exemplary diagram of generating balanced ledger entries in a book of accounts according to some embodiments herein. The exemplary diagram includes a first per unit price node 702 and an accounting entry creating module 706. The accounting entry creating module 706 processes the first invoice line item output among other inputs based on which, the first balanced ledger entry is automatically generated in a book of accounts. The first per unit price node 702 obtains the usage data of the first product and generates the first invoice line item output. For example, the first invoice line item output may be $50. The accounting entry creating module 706 obtains the first invoice line item output that is received from the first per unit price node 702 and generates a balanced accounting entries including a Credit entry to a Revenue account for Product A and an equal Debit entry to a Receivable account for Customer A. For example, the generated Credit entry to the Revenue account may be $50 for the first product and the corresponding balancing Debit entry to the Receivable account for Customer A may be $50.

The accounting entry creating module 706 obtains the first invoice line item output that is received from the first per unit price node 702 and generates a receivable amount. For example, the generated receivable amount may be $50 for a customer A. The receivable amount may be as the first entry.

The accounting entry creating module 706 processes the second invoice line item output among other inputs based on which, the second balanced ledger entry is automatically generated in the book of accounts. The accounting entry creating module 706 obtains the second invoice line item output that is received from the second per unit price node 704, and generates the balanced accounting entries including another Credit entry to the Revenue account for Product A and another equal Debit entry to the Receivable account for Customer A. For example, the generated Credit entry to the Revenue account may be $70 for the first product and the corresponding balancing Debit entry to the Receivable account for Customer A may be $70.

The user may approve the first invoice line item output and the second invoice line item output before sending to the accounting entry creating module 706. The user may approve the generated invoice line item output if the generated invoice line item output is greater than or equal to a threshold value. The approval from the user may not be required if the generated invoice line item output is below the threshold value of the generated invoice line item output. The user may approve the generated invoice line item output manually before sending it to the customer.

The entries that are created are automatically posted to the books of accounts of the user.

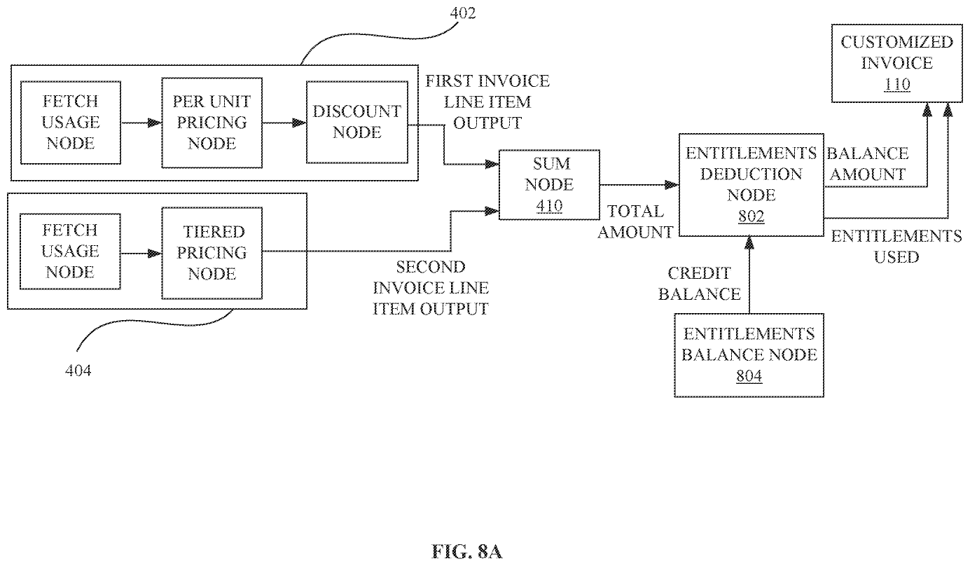

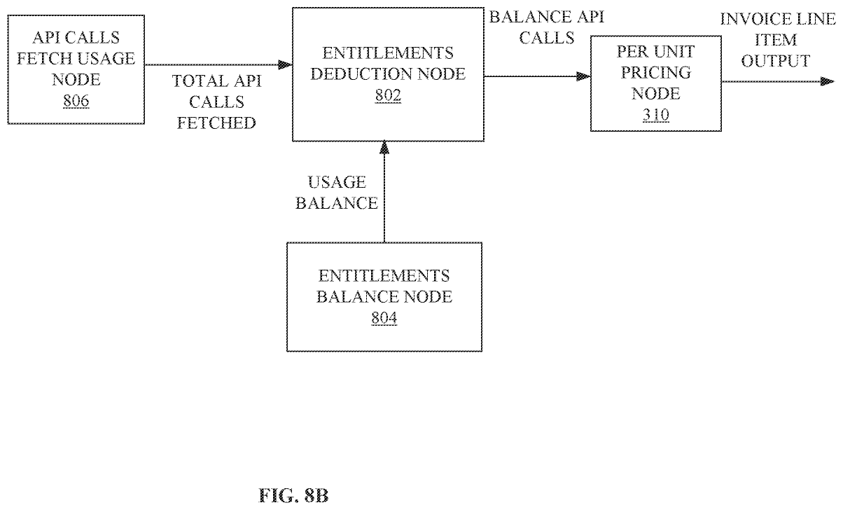

FIG. 8A illustrates an exemplary diagram of computing entitlements based on credits offered according to some embodiments herein. The exemplary diagram includes the DAG based contract of the first product 402, the DAG based contract of the second product 404, the sum node 410, an entitlements deduction node 802 and an entitlements balance node 804. The DAG based contract of the first product 402 further includes the fetch usage node, the per unit pricing node and the discount node. The DAG based contract of the first product 402 computes the first invoice line item output. The DAG based contract of the second product 404 further includes the fetch usage node and the tiered pricing node. The fetch usage node obtains the usage data of the second product. The DAG based contract of the second product 404 computes the second invoice line item output.

The sum node 410 computes the sum of the first invoice line item output and the second invoice line item output that are received from the DAG based contract of the first product 402 and the DAG based contract of the second product 404 respectively. Thereby, the total amount is generated based on the sum computed by the sum node 410. The entitlements deduction node 802 obtains the total amount from the sum node 410 and a credit balance from the entitlements balance node 804. The entitlements deduction node 802 computes the entitlements used and the balanced amount using the total amount and the credit balance. Thereby, the customized invoice is generated using the balance amount, and the entitlements used. The entitlements used may not be used to generate the customized invoice in some scenarios.

FIG. 8B illustrates an exemplary diagram of computing the invoice line item output for the number of API calls used by a customer according to some embodiments herein. The exemplary diagram includes an API calls fetch usage node 806, the entitlement deductions node 802, the entitlement balance node 804 and the per unit pricing node 310.

The API fetch usage node 806 obtains the total API calls that are used by the customer. The entitlements deduction node 802 obtains API call credits balance from the entitlements balance node 804, and the total API calls that are used by the customer from the API fetch usage node 806. The entitlements deduction node 802 computes the balance API calls by deducting the total API calls fetched from the API fetch usage node and the API call credits balance received from the entitlements balance node 804. The per unit pricing node 310 generates the invoice line item output by multiplying the balance API calls with the per unit price of the API calls. For example, if the total API calls that are used by the customer for a month are 2304 API calls, and the API call credits balance is 1000 API calls, then the balance API calls is 1304 API calls for the customer for that month. Thereby, the invoice line item output is calculated based on the balance API calls.

In an exemplary embodiment, the following code is used for generating the aggregated output usage API calls of the customer.

```
inputs:
  - external_service
  - customer
  - month
outputs:
  - aggregated_usage
computation:
  - outputs.aggregated_usage = (select aggregated_usage from
inputs.external_service where customer = inputs.customer and month =
inputs.month).
```

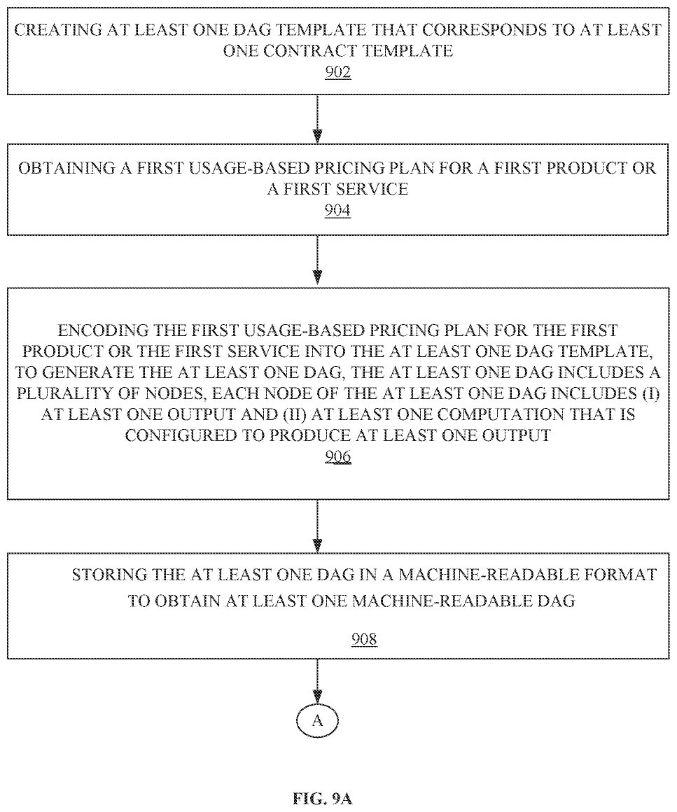

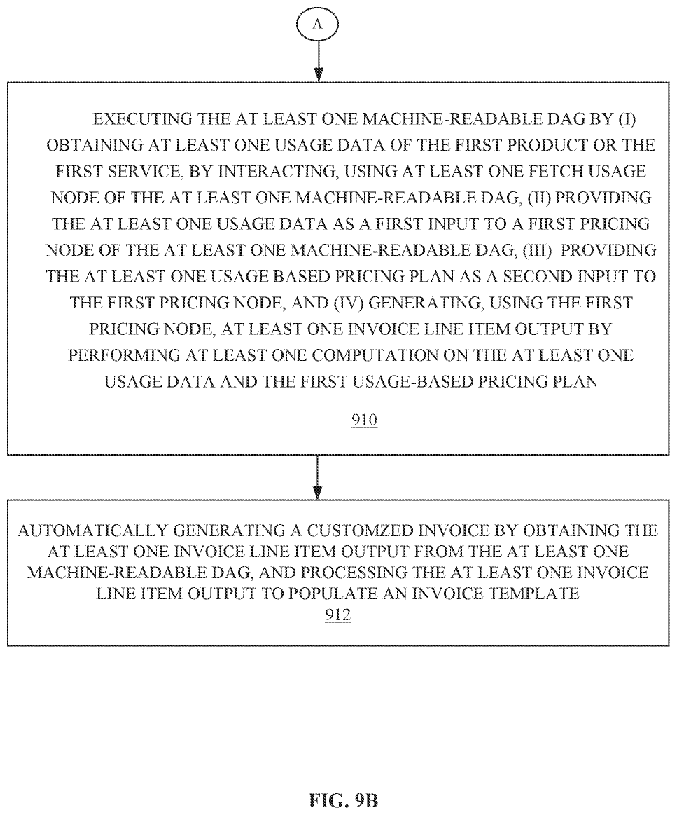

FIGS. 9A-9B are flow charts that illustrate a method for encoding at least one usage-based pricing plan corresponding to at least one product or service to generate at least one directed acyclic graph (DAG) in a machine-readable format, to automatically generate an invoice based on the at least one usage-based pricing plan according to some embodiments herein. At step 902, at least one DAG template that corresponds to at least one contract template, is created. At step 904, a first usage-based pricing plan for the first product or the first service, is obtained. At step 906, the first usage-based pricing plan for the first product or the first service is encoded into the at least one DAG template to generate the at least one DAG. The at least one DAG includes a plurality of nodes. Each node of the at least one DAG includes (i) at least one output, and (ii) at least one computation that is configured to produce the at least one output. At step 908, the at least one DAG is stored in a machine-readable format to obtain at least one machine-readable DAG. At step 910, the at least one machine-readable DAG is executed to (i) obtain at least one usage data of the first product or the first service, by interacting, using at least one fetch usage node of the at least one machine-readable DAG, (ii) provide the at least one usage data as a first input to a first pricing node of the at least one machine-readable DAG, the first pricing node stores the first usage-based pricing plan, (iii) provide the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan. At step 912, a customized invoice is automatically generated by obtaining the at least one invoice line output. In some embodiments, the method includes obtaining the at least one invoice line item output from the at least one machine-readable DAG, and processing the at least one invoice line item output to automatically generate balanced ledger entries in a book of accounts.

In an exemplary embodiment, the following code generates the DAG template corresponding to the contract template.

```
get_quantity1:
node: get_usage
  inputs:
  - external_service: <data_storage_details_for_product1>
  - customer: Customer1
  - month: 2022-10
  outputs:
  - aggregated_usage
free_units1:
  node: free_units
  inputs:
  - free_quantity: 500
  - quantity: get_quantity1.outputs.aggregated_usage
  outputs:
  - free_units_granted
  - remaining_quantity
pricing_model1:
  node: per_unit_price
  inputs:
  - price: 5 USD
  - quantity: free_units1.outputs.remaining_quantity
  outputs:
  - amount
get_quantity2:
  node: get_usage
  inputs:
  - external_service: <data_storage_details_for_product2>
  - customer: Customer1
  - month: 2022-10
  outputs:
  - aggregated_usage
pricing_model2:
  node: per_unit_price
  inputs:
  - price: 5 USD
  - quantity: get_quantity2.outputs.aggregated_usage
  outputs:
  - amount
sum:
  node: sum
  inputs:
  - pricing_model1.outputs.amount
  - pricing_model2.outputs.amount
  outputs:
  - total_invoice_amount
```

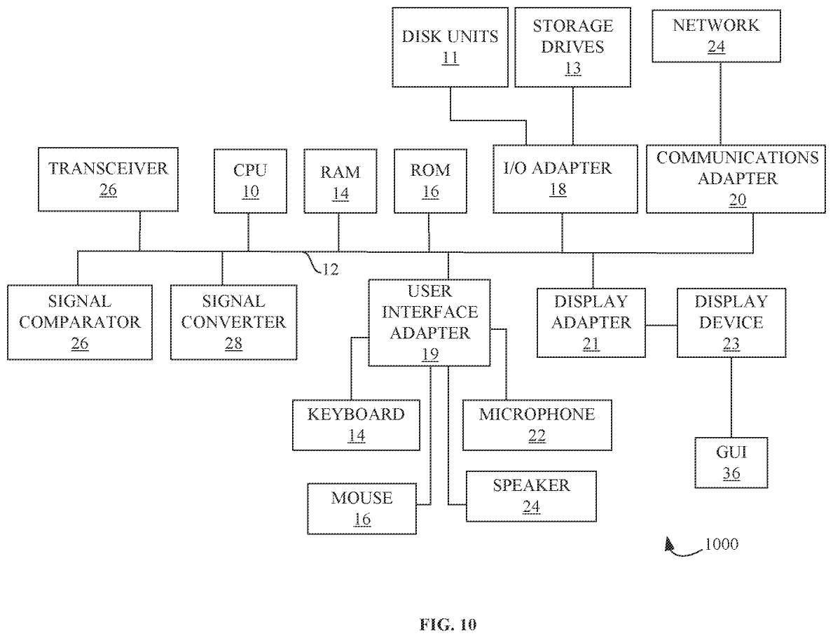

A representative hardware environment for practicing the embodiments herein is depicted in FIG. 10 with reference to FIGS. 1 through 9B. This schematic drawing illustrates a hardware configuration of system 1000, in accordance with the embodiments herein. The hardware configuration includes at least one processing device 10 and a cryptographic processor 11. The system 1000 may include one or more of a personal computer, a laptop, a tablet device, a smartphone, a mobile communication device, a personal digital assistant, or any other such computing device, in one example embodiment. The system 1000 includes one or more processor (e.g., the processor) or central processing unit (CPU) 10. The CPUs 10 are interconnected via system bus 12 to various devices such as a random-access memory (RAM) 14, read-only memory (ROM) 16, and an input/output (I/O) adapter 18. Although, CPUs 10 are depicted, it is to be understood that the system 1000 may be implemented with only one CPU.

The I/O adapter 18 can connect to peripheral devices, such as disk units 11 and storage drives 13 (tape drives), or other program storage devices that are readable by the system. The system 1000 can read the inventive instructions on the program storage devices and follow these instructions to execute the methodology of the embodiments herein. The system 1000 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing or executing program code will include at least one processor coupled directly or indirectly to memory elements through a system bus. The memory elements can include local memory employed during actual execution of the program code, bulk storage, Subscriber Identity Module (SIM) card, and cache memories which provide temporary storage of at least some program code in order to reduce the number of times code must be retrieved from bulk storage during execution. Input/output (I/O) devices (including but not limited to keyboards, displays, pointing devices, remote controls, camera, microphone, temperature sensor, accelerometer, gyroscope, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor implemented method for encoding a first usage-based pricing plan corresponding to a first product or a first service to generate at least one directed acyclic graph (DAG) in a machine-readable format, to automatically generate a customized invoice based on the first usage-based pricing plan when at least one event triggers execution of the at least one DAG, the method comprising:
creating at least one DAG template that corresponds to at least one contract template;
obtaining a first usage-based pricing plan for the first product or the first service;
encoding the first usage-based pricing plan for the first product or the first service into the at least one DAG template, to generate the at least one DAG, wherein the at least one DAG comprises a plurality of nodes, wherein each node of the at least one DAG comprises (i) a plurality of at least one outputs, and (ii) at least one computation that is configured to produce the at least one output;
storing the at least one DAG in the machine-readable format to obtain at least one machine-readable DAG;
executing the at least one machine-readable DAG by (i) obtaining at least one usage data of the first product or the first service, by interacting, using at least one fetch usage node of the at least one machine-readable DAG; (ii) providing the at least one usage data as a first input to a first pricing node of the at least one machine-readable DAG, wherein the first pricing node stores the first usage-based pricing plan; (iii) providing the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan; and
automatically generating a customized invoice by obtaining the at least one invoice line item output.

2. The method of claim 1, wherein the method further comprises
obtaining the first invoice line item output from the at least one machine-readable DAG; and
generating the first invoice line item output corresponding to the first product or the first service, a first credit entry, and a first debit entry based on the at least one line item output, thereby balanced credit entries and debit entries are computed to automatically update balanced ledger entries in a book of accounts.

3. The method of claim 1, wherein the method further comprises,
obtaining (i) the first usage-based pricing plan for the first product or the first service, and (ii) a second usage-based pricing plan for a second product or a second service; and
encoding the first usage-based pricing plan and the second usage-based pricing plan into the at least one DAG template, to generate the at least one machine-readable DAG.

4. The method of claim 3, wherein the method further comprises
generating, using the first pricing node and the second pricing node, a first invoice line item output corresponding to the first product or the first service and a second invoice line item output corresponding to the second product or the second service;
providing the first invoice line item output and the second invoice line item output as inputs to a sum node of the at least one machine-readable DAG; and
computing, using the sum node, the at least one invoice line item output by summing the first invoice line item output and the second invoice line item output.

5. The method of claim 1, wherein the method further comprises
obtaining at least one event data that comprises an information related to a context or a circumstance on which the at least one machine-readable DAG to be executed; and
triggering the at least one machine-readable DAG for execution in response to obtaining the at least one event data.

6. The method of claim 1, wherein the first usage-based pricing plan and the second usage-based pricing plan comprise at least one of a fixed per unit or use price, a fixed monthly price, a volume-based price, a tiered price, a custom currency-based price, a custom price, a currency conversion rate, free units, or a discount, wherein the first pricing node comprises at least one of a fixed per unit or per use pricing node, a fixed monthly pricing node, a volume-based pricing node, a tiered pricing node, a custom currency-based pricing node, a custom pricing node, a currency conversion node, a free unit node, or a discount node.

7. The method of claim 1, wherein the method further comprises generating the least one invoice line item output comprises,
obtaining the at least one event data for triggering execution of the at least one machine-readable DAG; and
executing the at least one machine-readable DAG according to an order of execution specified by the at least one machine-readable DAG for
obtaining, using the at least one fetch usage node, at least one of the at least one usage data, a custom currency balance, a coupon for discount, or a trial coupon;
deducting, using the free unit node, free units from the at least one usage data if the first usage-based pricing plan comprises the free units;
computing, using any of the fixed per unit or per use pricing node, the fixed monthly pricing node, the volume-based pricing node, or the tiered pricing node according to the order of execution, the at least one invoice line item output based on the at least one usage data or deducted usage data and the first usage-based pricing plan; and
deducting, using the discount node, a discount amount from the least one invoice line item output if the first usage-based pricing plan comprises a discount.

8. The method of claim 7, wherein the method further comprises generating the customized invoice further comprises,
populating an invoice template with at least one of the at least one usage data, a billing period, the free units, the deducted usage data, or the discount amount, and the at least one invoice line item output.

9. The method of claim 1, wherein generating the at least one invoice line item output comprises,
obtaining the at least one event data for triggering execution of the at least one machine-readable DAG; and
executing the machine-readable DAG according to an order of execution specified by the at least one machine-readable DAG for
obtaining, using the at least one fetch usage node, the at least one usage data;
deducting, using the free unit node, free units from the at least one usage data if the second usage-based pricing plan comprises the free units;
computing, using the custom currency-based pricing node, a custom currency-based invoice line item output based on the at least one usage data or deducted usage data; and
converting, using the currency conversion node, the custom currency-based invoice line item output into at least one currency format.

10. The method of claim 1, wherein the at least one DAG template comprises at least one placeholder for obtaining the first usage-based pricing plan, wherein the at least one placeholder is replaced by a node or the plurality of nodes by:
a) generating a user interface based on the at least one DAG template and obtaining the first usage-based pricing plan from a user via a user device to replace the at least one placeholder with the node or the plurality of nodes that stores the first usage-based pricing plan; or
b) obtaining, via an application programming interface (API), the node or the plurality of nodes and the first usage-based pricing plan for replacing the at least one placeholder with the node or the plurality of nodes that stores the first usage-based pricing plan.

11. The method of claim 1, wherein the plurality of nodes of at least one DAG are reused across a plurality of customers, to generate a customized DAG for each customer, by encoding the first usage-based pricing plan corresponding to each customer into the at least one DAG template.

12. The method of claim 1, wherein the method further comprises computing at least one used entitlements and a balance amount by,
obtaining, using an entitlements balance node and the sum node, the customized invoice and a credit balance; and
computing, by at least one entitlements deduction node, the at least one used entitlements and the balance amount using the customized invoice and the credit balance.

13. The method of claim 1, wherein computing the at least one invoice line item output comprises,
obtaining usage API calls from an API fetch usage node;
obtaining credit API calls from the entitlements balance node;
computing balance API calls by deducting the usage API calls that are received from the API fetch usage node and the credit API calls that are received from the entitlements balance node; and
computing the at least one invoice line item output by multiplying the balance API calls with the per unit price of the API calls.

14. A system for encoding a first usage-based pricing plan corresponding to a first product or a first service to generate at least one directed acyclic graph (DAG) in a machine-readable format, to automatically generate a customized invoice based on the first usage-based pricing plan when at least one event triggers execution of the at least one DAG, the system comprising;
a memory that stores a set of instructions; and
a processor that is configured to execute the set of instructions to
create at least one DAG template that corresponds to at least one contract template;
obtain a first usage-based pricing plan for a first product or a first service;
encode the first usage-based pricing plan for the first product or the first service into the at least one DAG template, to generate the at least one DAG, wherein the at least one DAG comprises a plurality of nodes, wherein each node of the at least one DAG comprises (i) a plurality of at least one outputs, and (ii) at least one computation that is configured to produce the at least one output;
store the at least one DAG in the machine-readable format to obtain at least one machine-readable DAG;
execute the at least one machine-readable DAG by (i) obtaining at least one usage data of the first product or the first service, by interacting, using at least one fetch usage node of the at least one machine-readable DAG; (ii) providing the at least one usage data as a first input to a first pricing node of the at least one machine-readable DAG, wherein the first pricing node stores the first usage-based pricing plan; (iii) providing the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan; and
automatically generate a customized invoice by obtaining the at least one invoice line item output.

15. The system of claim 14, wherein the processor is further configured to
obtain the first invoice line item output from the at least one machine-readable DAG; and
generate a first invoice line item output corresponding to the first product or the first service, a first credit entry, and a first debit entry based on the at least one line item output, thereby balanced credit entries and debit entries are computed to automatically update balanced ledger entries in a book of accounts.

16. The system of claim 14, wherein the processor is further configured to
obtain (i) the first usage-based pricing plan for the first product or the first service, and (ii) a second usage-based pricing plan for a second product or a second service; and
encode the first usage-based pricing plan and the second usage-based pricing plan into the at least one DAG template, to generate the at least one machine-readable DAG;
generate, using the first pricing node and the second pricing node, a first invoice line item output corresponding to the first product or the first service and a second invoice line item output corresponding to the second product or the second service;
provide the first invoice line item output and the second invoice line item output as inputs to a sum node of the at least one machine-readable DAG; and
compute, using the sum node, the at least one invoice line item output by summing the first invoice line item output and the second invoice line item output.

17. The system of claim 14, wherein the processor is further configured to
obtain at least one event data that comprises an information related to a context or a circumstance on which the at least one machine-readable DAG to be executed; and
trigger the at least one machine-readable DAG for execution in response to obtaining the at least one event data.

18. The system of claim 14, wherein the processor is configured to generate the least one invoice line item output comprises,
obtaining the at least one event data for triggering execution of the at least one machine-readable DAG; and
executing the at least one machine-readable DAG according to an order of execution specified by the at least one machine-readable DAG for
obtaining, using the at least one fetch usage node, at least one of the at least one usage data;
deducting, using the free unit node, free units from the at least one usage data if the first usage-based pricing plan comprises the free units;
computing, using any of the fixed per unit or per use pricing node, the fixed monthly pricing node, the volume-based pricing node, or the tiered pricing node according to the order of execution, the at least one invoice line item output based on the at least one usage data or deducted usage data and the first usage-based pricing plan; and
deducting, using the discount node, a discount amount from the least one invoice line item output if the first usage-based pricing plan comprises a discount.

19. The system of claim 14, wherein the processor is configured to generate the least one invoice output comprises,
obtaining the at least one event data for triggering execution of the at least one machine-readable DAG; and
executing the machine-readable DAG according to an order of execution specified by the at least one machine-readable DAG for
obtaining, using the at least one fetch usage node, at least one of the at least one usage data, a custom currency balance, a coupon for discount, or a trial coupon;
deducting, using the free unit node, free units from the at least one usage data if the second usage-based pricing plan comprises the free units;
computing, using the custom currency-based pricing node, a custom currency-based invoice line item output based on the at least one usage data or deducted usage data; and
converting, using the currency conversion node, the custom currency-based invoice line item output into at least one currency format.

20. A one or more non-transitory computer-readable storage mediums storing the one or more sequences of instructions, which when executed by the one or more processors, causes to perform a method of encoding a first usage-based pricing plan corresponding to a first product or a first service to generate at least one directed acyclic graph (DAG) in a machine-readable format, to automatically generate a customized invoice based on the first usage-based pricing plan when at least one event triggers execution of the at least one DAG, wherein the method comprises:
creating at least one DAG template that corresponds to at least one contract template;
obtaining a first usage-based pricing plan for a first product or a first service;
encoding the first usage-based pricing plan for the first product or the first service into the at least one DAG template, to generate the at least one DAG, wherein the at least one DAG comprises a plurality of nodes, wherein each node of the at least one DAG comprises (i) a plurality of at least one outputs, and (ii) at least one computation that is configured to produce the at least one output;
storing the at least one DAG in the machine-readable format to obtain at least one machine-readable DAG;
executing the at least one machine-readable DAG by (i) obtaining at least one usage data of the first product or the first service, by interacting, using at least one fetch usage node of the at least one machine-readable DAG; (ii) providing the at least one usage data as a first input to a first pricing node of the at least one machine-readable DAG, wherein the first pricing node stores the first usage-based pricing plan; (iii) providing the first usage-based pricing plan as a second input to the first pricing node of the at least one machine-readable DAG and (iv) generating, using the first pricing node, at least one invoice line item output by performing the at least one computation using on the at least one usage data and the first usage-based pricing plan; and
automatically generating a customized invoice by obtaining the at least one invoice line item output.
